(19) United States
(12) Patent Application Publication
(10) Pub. No.: US 2004/0127193 A1
(43) Pub. Date: Jul. 1, 2004

(54) Technique for identifying status of users and status of subscribers' accounts in a communications system

(76) Inventors: Timothy A. Timmins, Tigard, OR (US); Nathan B. Baker, Tigard, OR (US); John S. Miller, Canby, OR (US)

Correspondence Address: Alex L. Yip, Kaye Scholer LLP, 425 Park Avenue, New York, NY, 10022, US

(21) Appl. No.: 10/334,226

(22) Filed: Dec. 31, 2002

(51) Int. Cl. H04M 11/00; H04M 15/00

(52) U.S. Cl. 455/405; 455/408; 379/114.05; 379/127.01

(57) ABSTRACT

A communications system and method for handling a call to the system based on whether the caller is a subscriber. In one example, in an information assistance service communications system, if the user is a subscriber, the call may be directed to a first operator device for directory assistance, while if the caller is a non-subscriber, the call may be directed to a special operator device discuss billing and subscription options, for example. In another communications system and method, calls to the system by subscribers are handled based on the status of parameters of the calling subscriber's account, such as usage limits and expiration date of the caller's subscription, for example. In another communications system and method, expiration dates are monitored and notices about the expiration dates are sent to subscribers by a method chosen by the subscriber. Features of these systems and methods may be used together or separately.

### FIELD OF THE INVENTION

The invention relates to a communications system and method and, more particularly, to identifying a status of users of the system and monitoring a status of accounts of subscribers to the system. The communications system may be an information assistance service system, for example.

### BACKGROUND OF THE INVENTION

It is a common experience to use a wireline or wireless telephone to call an operator for information assistance. In a typical information assistance call, a caller identifies to the operator the name and address (sometimes city or area code) of a party whose telephone number is desired. In response, the operator locates the desired destination number using a computer database, for example. The destination number is then provided to the caller. The number may be provided by a computerized voice server which provides automated voicing of the number. The caller may be afforded an option to be connected to the destination number without the need of first terminating the information assistance call.

It should be noted that even though a user subscribes to a telephone service provided by a particular carrier (e.g., AT&T Wireless Services Inc.) or branding partner (e.g., Virgin), the information assistance service accessed through the telephone service may be contracted by the carrier to a third party, and is therefore run by an independent contractor. That is, carriers may contract different independent providers to provide information assistance services for them. When a subscriber to the carrier makes an information assistance call by dialing such typical access digits as “411,” “★555,” “555-1212,” “00,” “1-800-555-1212,” etc., because of the contractual relationship, the carrier would switch such an information assistance call to its contracted information assistance service provider to handle the call.

Independent providers may provide different information assistance services and service features in addition to directory assistance. For example, upon request, an operator may provide a user with information on regional restaurants, movie listings, and directions to various places and the ability to purchase goods and services, etc. The assignee of the present application is an information assistance service provider which provides, among others, personalized services and special service features, which are different or lacking from other providers. For instance, one such service feature is a StarBack® service feature described in U.S. Pat. No. 5,797,092, whereby a caller, after being connected to a desired party, may be connected back to the assistance service provider by pressing a “★” key on their telephone, or otherwise issuing a command (e.g., saying the word “operator”). Examples of the assignee's personalized services include private directory assistance service and foreign language directory assistance service, which are described, for example, in U.S. Pat. No. 5,966,437 and International Publication No. WO 01/35621.

Users may therefore be motivated to directly call independent information service providers for directory assistance and their other services. Users may pay the independent information service provider at the time of the call for that call, by credit card, for example, or may establish subscription accounts, facilitating their use of the system. Subscribers may pay for their subscription with a credit card, as well.

Subscription accounts of any type require extensive management. For example, a company may desire to correspond with a subscriber many months before a subscription expires to seek renewal of the subscription. Such contacts may be expensive and may also annoy the subscriber.

### SUMMARY OF THE INVENTION

In a communications system where subscribers and non-subscribers to the system may call the system for the system's services, the status of a caller as a subscriber or non-subscriber may determine how a call will be addressed. For example, non-subscribers using a communications system, such as an information assistance service system, have to arrange for payment at the time of the call. This takes time and slows the rate at which operators can provide information assistance to other callers. It would be advantageous for a communications system, such as an information assistance service system, to be able to automatically determine whether a caller is a subscriber to the system, to facilitate the handling of the call.

In accordance with a first embodiment of the invention, a method of operating a communications system is disclosed wherein the communication is handled based, at least in part, on whether the user is a subscriber. For example, if the user is a subscriber, the communication may be directed to a first operator device, such as an operator terminal and/or an operator telephone. The operator at the first operator device may be an information assistance operator. If the user is not a subscriber, the communication may be directed to a second operator device, such as a second operator terminal and/or second operator telephone. The second operator at the second operator device may discuss the advantages and services offered by the system and a offer a subscription to the system, for example. The special operator may also arrange for billing for the current call, such as with a credit card. Alternatively, different screens may be automatically displayed at an operator terminal based at least in part, on whether the user is a subscriber or not. In another alternative, an automated message may be played for a non-subscriber, listing options for the non-subscriber to select.

The status of a user as a subscriber or a non-subscriber may be determined based on identifiers received while establishing a communication with the user or after establishing the communication. For example, in a method of operating a communications system, signals, including an identifier, are received in establishing a communication with a user. It may be determined whether the user is a subscriber to the system based, at least in part, on the identifier.

The identifier may be an automatic number identification (“ANI”), for example, of the communications device from which the call is initiated. The automatic number identification may be a phone number of a user's wireline or wireless phone, for example. Numbers of originating communications devices are referred to herein as “communications numbers”. Information about a subscriber's account stored in memory of the system may be located based on the identifier.

Alternatively, in a communications system, a communication is established with a user and it is determined whether the user is a subscriber based, at least in part, on a voice print of the user. In yet another alternative, in an information assistance service communications system, a communication is established with a user making an information assistance call and it is determined whether the user is a subscriber based, at least in part, on an identifier received after the communication is established. The identifier may be a voice print, a personal identification number (PIN) or an account number, for example.

In accordance with another aspect of the first embodiment of the invention, a communications system is disclosed comprising an interface to receive signals to establish a communication with a user. The signals contain an identifier. Memory is provided to store identifying information of subscribers to the system. A processor is coupled between the memory and the interface. The processor is programmed to determine if the user is a subscriber based, at least in part, on the identifier and the identifying information in the memory. The system handles the communication based, at least in part, on whether the user is a subscriber.

In accordance with yet another aspect of the first embodiment of the invention, a communications system is disclosed comprising receiving means for receiving signals for establishing a communication with a user. The signals contain an identifier. Determining means are provided for determining if the user is a subscriber to the system based, at least in part, on the identifier. Handling means are provided for handling the communication based, at least in part, on whether the user is a subscriber to the system.

It would be advantageous to address the status of certain parameters of a subscriber's account with a subscriber when the subscriber calls the system. In accordance with a second embodiment of the invention, a method of operating a communications system is disclosed comprising handling a communication based, at least in part, on a status of at least one parameter of the subscriber's account.

For example, the parameter may be a usage limit established by the subscriber. Examples of usage limits include the number of calls made in a time period and the dollar amount of services provided. Multiple parties may be included in the same subscription, such as family members, and different usage limits may be applied to different family members. The communication can be handled in different ways based, at least in part, on whether the usage limit is exceeded or if current usage is within a predetermined range of the usage limit. If a user limit is exceeded, the communication may be terminated, for example. Alternatively, the call may be directed to a particular operator device to be addressed by an operator dedicated to handling such situations. If the usage limit is not exceeded, the call can be handled in an ordinary manner, which, in an information assistance service system, for example, may involve directing the call to a different operator device to be addressed by a different operator.

The parameter may also be the expiration date of the subscription. If the expiration date of the subscription has been exceeded or if the current date is within a predetermined period of time before the expiration date, for example, the communication can be handled differently than other communications. If the subscription has already expired, or is close to expiring, the call may be directed to the operator device to be addressed by a special operator or credit may be extended for the call, for example. If not, the call may be directed to an information assistance operator device to be addressed by an information assistance operator.

Handling of the communication may be based on multiple parameters, such as both the usage limit parameter and the expiration date parameter, as well.

As in the first embodiment described above, in a method of operating a communications system, the identity of the subscriber may be determined based, at least in part, on an identifier in signals received in establishing a communication with the subscriber, such as an ANI. The identity of the subscriber may also be determined based on a voiceprint of the subscriber after the communication is established.

Also, as in the first embodiment, in a method of operating an information assistance service communications system, the identity of the subscriber may be determined based on an identifier received after the communication is established. The identifier may be a voice print, a personal identification number (PIN) or an account number, for example.

In accordance with another aspect of the second embodiment of the invention, a communications system is disclosed comprising an interface to receive signals to establish a communication with a user, wherein the signals contain an identifier. Memory is provided storing identifying information of subscribers to the system. A processor is provided coupled between the memory and the interface. The processor is programmed to determine if the user is a subscriber based, at least in part, on the identifier. The system handles the communication based, at least in part, on a status of at least one parameter of a subscriber's account. Possible parameters include usage limits and expirations dates, for example, as discussed above.

In accordance with yet another aspect of the second embodiment of the invention, a communications system is disclosed comprising means for receiving signals to establish a communication with a subscriber to the system, wherein the signals contain an identifier. Means are provided for identifying the subscriber based, at least in part, on the identifier. Means for handling the communication based, at least in part, on a status of at least one parameter of a subscriber's account are provided, as well. As mentioned above, usage limits and expiration dates are examples of parameters.

It would also be advantageous to inform subscribers of the expiration dates of their subscriptions via a method selected by the subscriber. In a third embodiment of the invention, a method of operating a communications system is disclosed comprising informing subscribers of an expiration date of their subscription by a contact preference method selected by the subscriber. The expiration date and the contact preference method may be stored in memory of the system, or elsewhere. The contact preference method may be a phone call, a facsimile, an e-mail, a notification on the system's website, a page, an SMS message, a wireless application protocol (WAP) message, an instant message and/or a letter, for example.

In accordance with another aspect of the third embodiment of the invention, a communications system is disclosed comprising memory storing subscriber information, including an expiration date of the subscription, and a contact preference method selected by the subscriber. A processor is provided, programmed to inform a subscriber of an expiration date via the contact preference method stored in memory. A transmission station may be coupled to the processor to enable transmission of a message to the subscriber. Examples of contact preference methods are listed above. The communications system may be an information assistance service system, comprising an interface to receive signals to establish a communication connection with a user and an information assistance service provider coupled between the interface and the processor.

In accordance with yet another aspect of the third embodiment of the invention, a communications system is disclosed comprising means for informing a subscriber of an expiration date by a contact preference method selected by the subscriber.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates a communications system, here an information assistance service system, including information assistance service centers (“IASCs”) and an information hub in accordance with one embodiment of the invention;

FIG. 2a illustrates an IASC of FIG. 1, in more detail;

FIG. 2b illustrates a gateway of FIG. 2a, in more detail;

FIG. 3 is a flowchart of an example of a method of operating a communications system in accordance with one embodiment of the invention, wherein a communication is handled based, at least in part, on the status of the user as a subscriber or a non-subscriber;

FIG. 4a is a flowchart of an example of a method of operating a communications system in accordance with a second embodiment of the invention, where a communication is handled based, at least in part, on a parameter of a subscriber's account, here usage limits;

FIG. 4b is an optional continuation of the flowchart of FIG. 4a;

FIG. 5 is a flowchart of another example of a method of operating a communications system in accordance with the second embodiment of the present invention, where the parameter is an expiration date of a subscriber's account;

FIG. 6 is a flowchart of a method of operating a communications system in accordance with a third embodiment of the invention, where subscribers are notified of expiration dates of their subscription by a method they have selected; and

FIG. 7 illustrates an alternative IASC for use in the system of FIG. 1.

### DETAILED DESCRIPTION

An aspect of the invention is directed to a system and a method for identifying non-subscribers to a communications system among users communicating with the system and handling non-subscribers differently than subscribers. For example, the communications service may be an information assistance service system. Subscribers calling the system may be directed to a first operator device, such as an information assistance terminal and/or an operator phone, to receive information assistance from an operator at the device, while non-subscribers may be directed to a second operator device to be addressed by another operator. The operator at the second operator device may discuss the services offered by the system, offer the non-subscriber a subscription to the system, and/or arrange for payment of the current call, without slowing consideration of subscribers. Alternatively, a different screen may be displayed at an operator device dependent on the status of the user. The screen may contain different prompts or scripts for use by the operator in communicating with the user. In another alternative, an automatic message may be played for non-subscribers, presenting options for selection. Parties may communicate with the communications system by a communications device, such as a wireline telephone, a wireless telephone, a personal digital assistant (“PDA”) or other communications devices. Subscribers may be identified by the system based on an identifier in the signals used to establish the communication, such as an automatic number identification (“ANI”) or by other methods after the communication is established, such as a voice print, personal identification number (PIN) or account number.

Another aspect of the invention is directed to a system and a method of operating a communications system, such as an information assistance service system, by handling communications with the system by a subscriber based, at least in part, on the status of at least one parameter related to the subscription. For example, subscribers may establish limits on usage of the system. Such limits include the total number of contacts, such as phone calls, to the system, the number of contacts in a predetermined time period, dollar amounts of services provided, etc. If current usage (including the current call) is within a predetermined range of a usage limit, the call may be directed to a special operator to discuss extension of the usage limits, for example. If the usage limit is not within the predetermined range, the call may be directed to a information assistance operator. Alternatively, the user may be informed by an automatic message that the usage limit will expire soon and the user may be given the option of being directed to an operator at a special operator terminal to discuss extension of the limit. If the usage limit has expired, the call may be directed to an operator at a special operator terminal or the user may be informed of the expiration by an automatic message. The caller may be allowed to complete the call or the call may be ended unless the user extends the limit.

Another such parameter is the expiration date of the subscription. If the subscription is within a predetermined time period prior to expiration, such as within one month of expiration, the call may be directed to an operator at a special operator terminal to discuss renewal or extension of the subscription. If the subscription is not within the predetermined time period, the call may be directed to a information assistance operator. Alternatively, if the subscription is within the predetermined range, an automatic message may be played, informing the user of the expiration date and giving the user an option to speak to the special operator to discuss renewal or to speak to an information assistance operator.

Another aspect of the invention is directed to system and method for monitoring the expiration dates of subscriptions to the communications system, such as an information assistance service system, and notifying subscribers of the pending expiration, and/or an actual expiration, by a method chosen by the subscriber.

These inventions may be used together or separately in a communications system.

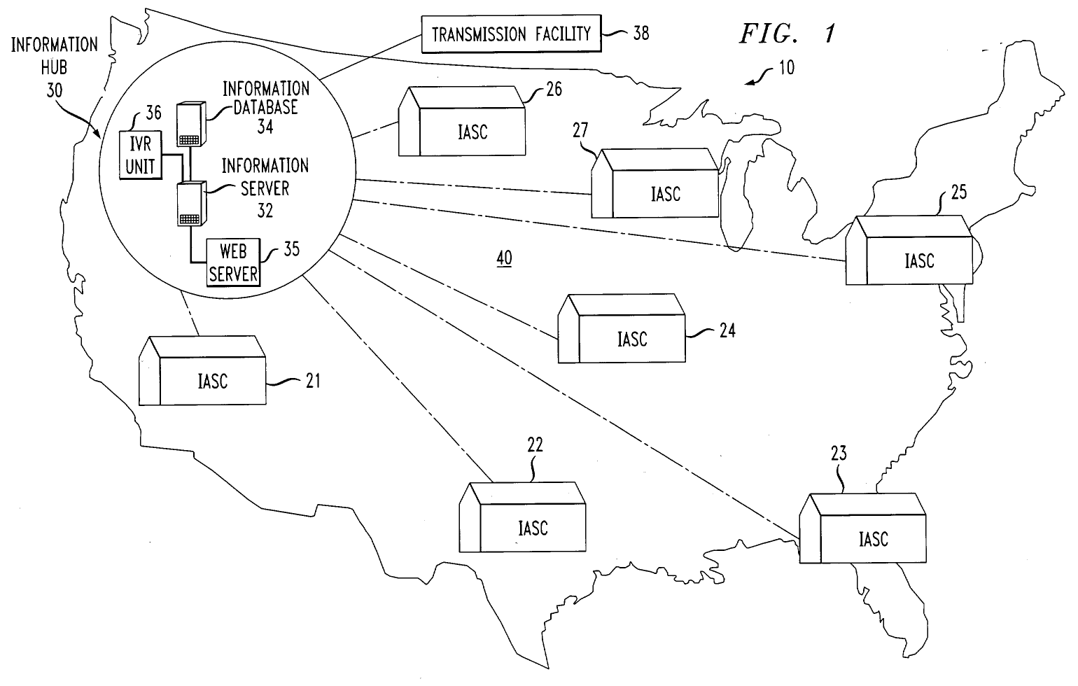

FIG. 1 illustrates an example of a communications system 10 for implementing the present inventions. In this example, the communications system 10 is an information assistance service system. The information assistance service system 10 includes a plurality of operators dispersed throughout a wide coverage area in information assistance service centers (“IASCs”) 21 through 27. IASCs 21 through 27 are coupled to each other and to one or more information hubs 30 through a network 40. The network may be a wide area network (“WAN”) 40 covering an extensive area, for example. WAN 40 can be an Internet-based network, such as the World Wide Web, or a private intranet based network. In this example, each of IASCs 21 through 27 covers one or more regional coverage areas. Information assistance service system 10 may be accessed directly by a user on a wireline phone, wireless phone, personal data assistant (“PDA”) and other communications devices.

Information hub 30 may include one or more processors, such as information server 32, which is accessible by the operators in the system 10, and one or more memory devices, such as information database 34, in which identifying information about each subscriber is stored and maintained. The user information may be in the form of individual subscriber folders for each current subscriber. Folders may be maintained for former subscribers, as well. Each folder may be associated with one or more communications numbers of the respective subscriber's communications devices. For example, the communications number may be a phone number of a subscriber's wireline or wireless phone. The communications number may be the ANI. The presence or absence of a subscriber folder corresponding to a phone number or other such identifying data may be used to indicate whether a caller is a subscriber to the system or not.

The folder may include a user profile, as described in application Ser. No. 09/865,230, filed on May 25, 2002 (“the '230 application”), assigned to the assignee of the present invention and incorporated by reference herein. The user profile may contain preferences of the subscriber related to subscribed services, such as preferred ways of receiving the services, and methods of delivering information to the subscriber. Information server 32 may include clock and calendar functions.

These personal preferences may be specified by a subscriber during a telephone service registration with system 10, for example. They may be established by the subscriber in response to direct registration questions by an operator or through an Internet page, for example.

Subscriber folders and other such information may also be stored locally at one or more of the IASCs 21 through 27, as described in the '230 application, as well. Local storage may speed access to the information by a respective IASC 21 through 27. The folders and information at different IASCs may be synchronized. Synchronized databases provide necessary backup as well as support to roaming mobile device users.

A communications number of a communications device initiating a call may be identified by the system 10 when a user calls the system based on an identifier in the call set up signals used to establish a communication, such as an automatic number identification (“ANI”), as is known in the art.

A web server 35 may also be provided in information hub 30, coupled to information server 32 and/or other servers. Subscriber's account information may be stored in web server 35. The system's web site may also be stored on web server 35 or in another server. Web server 35 may be coupled to system 10 at other locations, as well.

Interactive voice response unit (“IVR”) 36 may also be provided, coupled to information server 32, to send automated messages through transmission facility 38, as discussed further below.

While information assistance service system 10 in this example includes a plurality of IASCs 21 through 27, the invention may be implemented in a system including a single IASC coupled to an information hub.

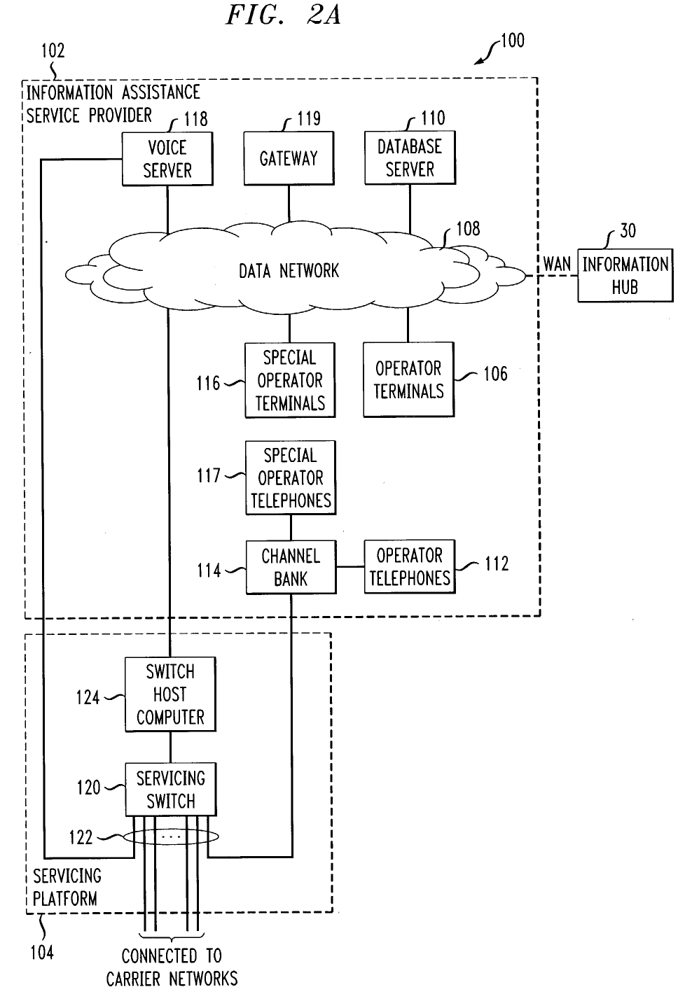

FIG. 2a illustrates an example of an IASC 100, which generically represents one of aforementioned IASCs 21 through 27, in more detail. IASC 100 comprises information assistance service provider (“IASP”) 102 and servicing platform 104. Servicing platform 104 may be part of IASP 102 or separate from it. Servicing platform 104 may be located in the same geographic area or in a different geographic area than the associated IASP 102.

The one or more operators in IASP 102 are equipped with operator terminals 106, each of which includes a video display unit and a keyboard with associated dialing pad (not shown). Operator terminals 106 are connected over data network 108 to one or more database server(s) 110 (although only one is shown here) containing information assistance information. The operators are also equipped with operator telephones 112 connected to channel bank 114. One or more special operator terminals 116, equipped in a similar manner as operator terminals 220, are also coupled to data network 108, in accordance with this embodiment of the invention. Special operators at special operator terminals use special operator telephones 117, also coupled to channel bank 14.

By way of example, data network 108 includes a local area network (LAN) supplemented by a number of point-to-point data links. Through data network 108 and routers (not shown), components of IASP 102 may also be connected to the Internet.

IASP 102 also includes gateway 119 connected to data network 108. Gateway 119 contacts information hub 30 to request information, as discussed further below. Gateway 119 may comprise interface 119a, processor 119b and memory 119c, as shown in FIG. 2b. Memory 119c here generically includes disks, caches and volatile and non-volatile memory.

Servicing platform 104 includes an interface, such as a servicing switch 120, to receive a communication. Servicing switch 120 includes T1 spans 122 for connection to voice server 118 and channel bank 114 of IASP 102 and to carrier networks. Switch 120 may receive an incoming information assistance call from one of the carrier networks through a carrier switch therein (not shown). Switch 120 may also be used to place an outgoing call through one of the carrier networks, which may be different than that used for an incoming call. Channel bank 114 in IASP 102 couples multiple operator telephones 112 in IASP 102 to switch 120 in servicing platform 104.

Servicing platform 104 also includes switch host computer 124, which is also coupled to data network 108 of the IASP 102. Switch host computer 124 may be programmed to control the operation of servicing switch 120, as well as the operation of the components of IASP 102. Switch host computer 124 may also be programmed to extract an identifier, such as the ANI, from the call set up signals of an incoming call, and derive a phone number of the communication device initiating the call, as is known in the art.

Switch 120 is conventional and supports digital T1 connectivity. The operation of switch 120 is governed by instructions stored in switch host computer 124. In this illustrative embodiment, switch 120 includes, inter alias, arrays of digital signal processors (“DSP”). These DSPs can be programmed and reprogrammed to function as, among other things, call progress analyzers (CPAs), call progress generators (CPGs), multi-frequency (MF) tone generators/detectors, dual-tone multi-frequency (DTM) generators/detectors, or conference units, depending on the demand placed on IASC 100 and switch 120 for each corresponding function.

Operators at operator terminals 106 may access database server 110 to obtain requested information, such as a user's desired party and the appropriate destination telephone number of the party, by conducting searches for the requested information. Other information assistance or specialized communications services, such as restaurant recommendations, movie listings, events, special offers, etc., may also be provided by searching database server 110.

Voice server 118 (e.g. a voice response unit (VRU)) is used to play the constant repeated parts of an operator's speech, namely, the various greetings and signoffs (or closings). Voice server 118 is connected via data network 108 to switch host computer 124 and via one or more T1 spans to switch 120. Voice server 118 may comprise a general purpose computer and one or more voice cards for voice recognition, voice recording and playback, and call progress analysis. At appropriate stages in a call progression, switch host computer 124 initiates a voice path connection between voice server 118 and switch 120 such that the user, or the user and the operator, are able to hear whatever pre-recorded speech is played on that connection by voice server 118. Switch host computer 124 then instructs voice server 118, via data network 108, what type of message to play, and passes data parameters that enable voice server 118 to locate the message appropriate to the call.

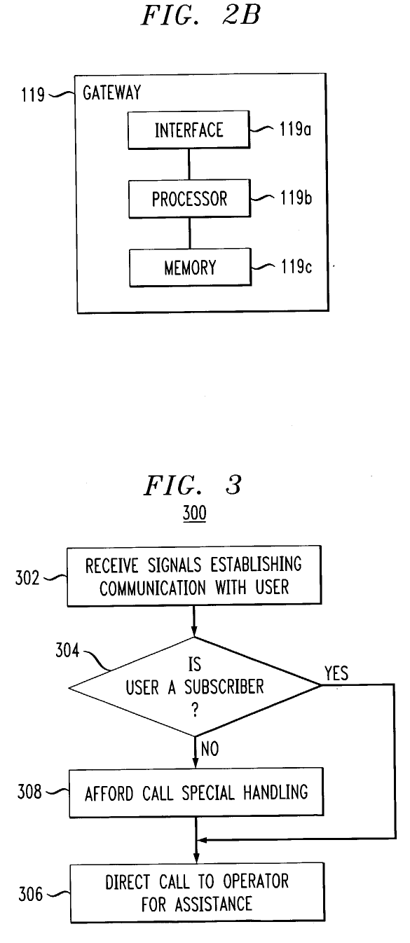

A method in accordance with an embodiment of the invention will be explained in conjunction with flow chart 300 of FIG. 3. When a user calls information assistance service system 10 in accordance with this embodiment, signals are received by system 10 to establish a communication, in step 302. The signals contain an identifier, such as an ANI, which identifies a phone number, or other such communication number of the communication device initiating the communication. A communication to system 10 may be routed to IASC 100, for example, where switch 120 receives the call setup signals to establish the communication.

It is then determined whether the user is a subscriber, in step 304. For example, switch host computer 124 may extract the ANI from the call setup signals and transmit the ANI to components of IASC 100, including gateway 119, through data network 108. Interface 119a of gateway 119 may receive the ANI and convey the ANI to processor 119b. Processor 119b then requests information server 32 of information hub 30 (see FIG. 1) for a subscriber folder associated with the ANI or a communications number corresponding to another identifier in the call set up signals, via WAN 40. Information server 32 then searches information database 20 for such a subscriber folder. If a folder is found, it is sent to gateway 119, via WAN 40. The folder may be stored in memory 119c. Location of a folder may indicate that the caller is a current subscriber. If folders of expired subscriptions are also maintained, the folder may be checked by information server 32 or gateway 119 to determine if the subscription is current.

In another example, system 10 determines whether the user is a subscriber or not based on an identifier provided after the communication is established with the user. The identifier may be a voice print of the user, a personal identification number (“PIN”) of the user or an account number of the user, for example. The voice print, PIN and/or account number may be stored in the subscriber's folder and/or in other locations. The user's voice print is derived from the user's verbal statements after the communication is established. The user's PIN number and/or account number may be entered verbally or via input devices on the user's communications device. A recorded message may prompt entry of sufficient verbal statements for a voice print, and/or recitation or entry of a PIN and/or account number. Information server 32 may identify a subscriber folder associated with the voice print, PIN or account number and send the folder to Gateway 119, as described above.

If a folder for a current subscriber is found, the call is directed to an operator at an operator device for information assistance, in step 306. For example, as mentioned above, information server 32 may send the subscriber folder to gateway 112 over WAN 40 and data network 108. Gateway 119 may then send a signal to switch host computer 124 indicating that the user is a current subscriber. Switch host computer 124 may then direct the communication to an available operator terminal 106 and operator telephone 112 for handling by an operator in an ordinary manner to provide the information assistance requested by the caller. Gateway 119 or switch host computer 124 may also send the subscriber folder to the operator terminal 106 of the operator handling the communication. The operator may verify that the caller corresponds to the subscriber folder by comparing the name and/or personal identification number (“PIN”) of the caller to that in the folder.

If no operator is available at one of operator terminals 106 when a call is received, the call may be queued in a conventional manner until an operator becomes available. In this instance, automatic call distribution (ACD) logic of conventional design (not shown) may be used to queue and distribute calls to operators at operator devices in the order in which they are received, and such that the call traffic is distributed evenly among the operators. The ACD logic may reside in switch host computer 124 or elsewhere in system 10. In other instances, other distribution logic schemes may be utilized, such as skills-based routing or a priority scheme for preferred users.

If the caller is not a current subscriber, as indicated by failure to locate a current subscriber folder associated with the ANI or communications number, the communication is accorded special handling in step 308. For example, gateway 119 may send a signal to switch host computer 124 indicating that no current folder was found. Switch host computer 124 then directs the communication to a special operator device, such as special operator terminal 116 and special operator telephone 117, for special handling. An operator device may be designated as a “special” operator device because of its being completely or partially dedicated for use with non-subscribers. It may or may not have a different configuration or be programmed differently than other operator devices used in IASC 100.

Special handling by the special operator in this embodiment includes discussing with the user billing options, such as temporary (call-by-call), where a user pays for each call as it is made with a credit card, for example, or a subscription for a predetermined period of time. A subscription may also be defined by other terms, such as a predetermined number of calls. The special operator may also discuss enhanced services that may be offered by the information service system, if any. The caller may establish a user profile at that time, or at a later time, including personal preferences of a subscriber relating to use of enhanced assistance service features, methods of transmission of special offers, etc., that may be included in the subscriber folder. If a non-current folder is found, the folder may be sent to the special operator terminal 116 of the operator handling the call, to facilitate communication with and updating the information about the former subscriber and to discuss establishment of a new subscription.

The special operator may then collect from the user the credit card number and other information necessary to establish the appropriate billing relationship.

After the special operator has completed the processing of the user, the call is directed to an operator device such as operator terminal 106 and/or operator telephone 112 for information assistance in step 306, as discussed above. The call may be directed by switch host computer 124. In accordance with this method, an information assistance operator at operator terminal 106 did not need to take the time to collect billing information or explain system 10 services to non-subscribers, giving them more time to provide information assistance. By providing special operators at special operator devices, dedicated to dealing with non-subscribers, system resources may be more efficiently allocated.

Instead of directing the communication to a special operator at a special terminal 116, the communication may be directed to an available operator at an operator terminal 106, with an indication that the caller is not a subscriber. The indication may be lack of presentation of a subscriber folder on the terminal display, or automatic appearance of a special screen with prompts and/or scripts for handling non-subscribers, for example. By determining the status of a user prior to the call being directed to an operator, the communication may be handled more quickly and efficiently.

In another alternative, instead of directing a call to a special operator and special operator terminal 116, once a user is identified as a non-subscriber, an automatic message may be played giving the user billing options and subscription information. Switch host computer 124 may direct voice server 118 to play appropriate messages. If the user's communications device is capable, the user may select options and input data, such as credit card information, to set up a subscription or pay for the current call. The call may then be directed to an operator for information assistance in step 306. One option in the automated message may be connection to a special operator, to discuss subscription options and answer questions, in step 308, as discussed above.

In addition to or instead of subscriber folders, the identifier (subscriber communication numbers, voice prints, PINs and/or account numbers, etc.) may be stored in information database 34 or in another memory location in a listing separate from the subscriber folders. Instead of searching for subscriber folders, information server 32 may then search a listing of the identifiers to determine if a user is a subscriber, in step 304. In that case, gateway 119 may not be required in IASC 100 and the request for information about the status of a user may be made by switch host computer 124 to information server 32 via WAN 40, as indicated by dotted lines in FIG. 2. Even if subscriber folders are being searched to determine if a user is a subscriber, information server 32 may conduct those searches and inform switch host computer 124 whether a folder of a current subscriber has been found. However, if a folder is to be provided from information database 34 to an operator terminal at IASC 100, use of a gateway, such as gateway 119, is preferred.

In accordance with another embodiment of the invention, one or more parameters of a subscriber's account may be monitored while a subscriber is connecting with, and is connected with, system 10. This may facilitate communication with the subscriber about their account. Such parameters may be stored in subscriber folders or in other locations in information database 34 or other memory devices. Such parameters include usage limits on the subscription or aspects of the subscription and the expiration date of the subscription, for example.

Examples of usage limits include limits on the total number of calls, the number of calls per time period (10 calls per month, for example), the total charges in dollars of calls made, the total charges in dollars per time period, the duration of individual calls or the type of information assistance requested (domestic or foreign, for example) that may be made and billed to a particular subscription and/or credit card number supporting the subscription. The limits may be established for other authorized users of the credit card, such as family members. Each authorized user may have a common personal identification number (“PIN”) or a unique PIN. Different limits may then be set for different authorized users with unique PIN numbers. The limits may be stored in a subscriber folder associated with the subscriber, or in other files or folders.

The current level of usage (number of calls made, including the current call, for example) may also be stored in the subscriber folder or in another folder in information database 34. Switch host computer 124 may be programmed to inform information server 32 of each call initiated by a user when a call is received. Information server 32 may be programmed to update the level of usage in the folder when each call is made, or to periodically update the level of usage. Information server 32 may also be programmed to compare the usage limit to the current level of usage.

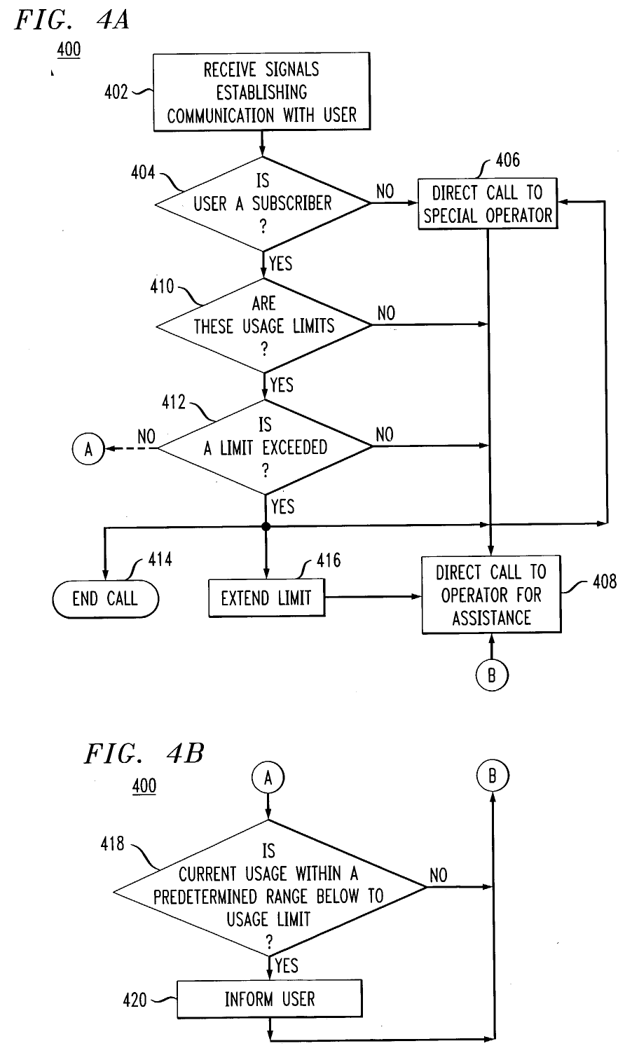

One embodiment of this aspect of the invention will be described with respect to flowchart 400 in FIG. 4a and FIG. 4b. Signals establishing a communication with a user are received in step 402 and the status of the user as a subscriber or non-subscriber is determined in step 404. If the user is not a subscriber, the call may be directed to a special operator for special handling in step 406. The call is then directed to an operator for information assistance in step 408. Steps 402, 404 and 406 correspond to steps 302, 304 and 306 in flowchart 300 of FIG. 3. Directing a call from a non-subscriber to a special operator device in step 406, prior to the call being directed to an information assistance operator device in step 408, is optional in this embodiment.

If the user is a subscriber, it is determined whether usage limits have been established in the subscription, in step 410. For example, as discussed above, switch host computer 124 may be programmed to inform information processor 32 of the phone number of the call, to determine if a user is a subscriber. If information server 32 identifies a subscriber folder of a current subscriber corresponding to the phone number, information server 32 may be further programmed to check the folder, or another folder or location, for a usage limit. If no usage limit is associated with a subscriber, the call is directed to an operator for information assistance, in step 408.

In one example shown in FIG. 4a, if it is determined that there are usage limits, it is then determined whether a limit is exceeded in step 412. For example, information server 32 may be programmed to increment the current value of a usage limit to reflect the current call and compare the incremented value with the usage limit. If the usage limit is not exceeded, the call is directed to an available operator for information assistance, in step 408. For example, information server 32 may send a signal to switch host computer 124 to indicate that no usage limit is exceeded. Switch host computer 124 may then direct the call to an available operator at an operator terminal 106.

If it is determined that a usage limit is exceeded, there are several options. In the example of FIG. 4a, the call may be ended, as in step 414, the limit may be extended to allow the current call to be completed, as in step 416, or the call may be directed to a special operator in step 406, to discuss extension of the limit, for example. The same special operators at special operator terminals 116 that handle non-subscribers may handle usage limit issues, as well. Alternatively, other special operators may be used at other terminals. If the limit is extended, the call is directed to a information assistance operator in step 408.

An automatic message may be played by voice server 118 if the call is to be ended or if the limit is to be extended, to inform the user. The message may also include options for selection, such as to end the call, request credit or direct the call to the special operator.

A subscriber may determine how a call should be handled (ended, extend limit or direct call to operator) when a usage limit has been exceeded in a pre-established personal preference stored in the subscriber's folder.

Alternatively, or in addition, the system may decide how the call is to be handled. Extending the limit may involve advancing the subscriber money credit. For example, a usage limit may be $50 per month, for example, and a current call may place the total charges that month to over $50. The credit history information of the subscriber with system 10 and/or credit history based on a credit history report may be stored in information database 34 or in another accessible memory. Information server 32 or another processor may then also be programmed to evaluate whether credit should be extended based on the credit history. Credit may be extended more readily if it is the current call that causes the usage limit to be exceeded and/or if credit has not been extended before. There may be a limit on the amount of credit that may be extended in general or for each particular subscriber.

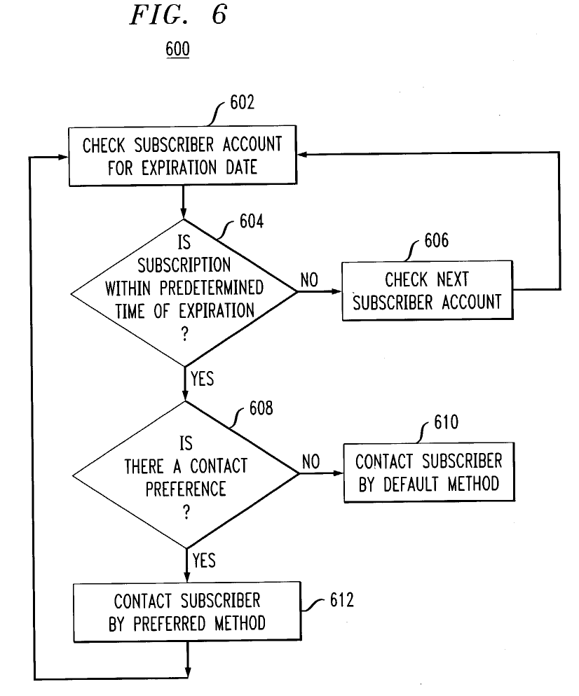

As discussed, above, a subscriber may allow others, such as family members, to make calls on the subscriber's subscription. Each party using the same subscription may have a different PIN. Particular options may be designated for each party. For example, for one family member, such as a child, the end call option of step 414 may be selected whenever a usage limit is exceeded. For another family member, such as a spouse, the credit option of step 416 may be selected whenever a usage limit is exceeded. Alternatively, the credit option may be allowed only a predetermined number of times, after which the call is ended in step 416 or directed to a special operator device and operator in step 406. Information server 32 may be programmed to determine which option, if any, is preferred and to provide appropriate signals to switch host computer 124 to direct the call. Particularly when multiple parties are involved, a primary subscriber may request notification when a usage limit is exceeded by another party to the subscription. Such notifications may be provided by a variety of methods, as discussed below with respect to the embodiment of FIG. 6.

In another alternative, if the limit is not exceeded, system 10 may determine whether the current call places current usage within a predetermined range below the usage limit, in step 418 in FIG. 4b. If so, the user is informed that a usage limit is being approached, in step 420. The call may then be directed to an operator for information assistance in step 408 (FIG. 4a). Again, if multiple parties are part of the same subscription, the primary subscriber may receive notice that current usage is within a predetermined range of the usage limit.

Information server 32 may be programmed to determine if the current usage level is within a predetermined range below the usage limit by looking at the difference between the usage limit and the incremented current value and comparing the difference to the predetermined range. For example, if the usage limit is 10 calls per month, the predetermined range is two calls, and the current incremented value is 8, 9 or 10, the current usage is within the predetermined range.

The information server 32 may then instruct switch host computer 124 to cause voice server 118 to play an automatic message prior to computer 124 directing the call to an operator for assistance. The subscriber may be informed that a usage limit is close to being exceeded by other methods, such as a separate phone call, regular mail, facsimile, e-mail, and other methods discussed below. The subscriber may also select a preferred method of contact, which may be stored in the subscriber folder, for example. The automatic message may offer options, such as extending the limit through the current phone call and directing the call to a special operator at that time, which may be selected by proper input of data through the user's phone or other such communications device. Switch host computer 124 may be programmed to respond to the selection.

When new subscribers join the system, they may be given the option of creating such limits. Existing subscribers may establish or change such limits at any time.

Another example of a parameter that may be monitored by system 10 during a call with a subscriber in accordance with the invention is the expiration date of the subscription. The subscription term and expiration date may be stored in the subscriber's folder or in another folder or location. If the expiration date is within a predetermined amount of time, such as 30 days, from the expiration date, the call may be directed to a special operator to discuss renewal of the subscription. Enhancements to the subscription with additional services may be discussed, as well. The same special operator at one of the special operator terminal 116 that handles non-subscribers may handle expirations, as well, or other operators may be used.

If the subscription has expired, similar options may be provided as discussed above with respect to expiration of a usage limit. For example, a call may be ended, credit may be extended or the call may be directed to a special operator.

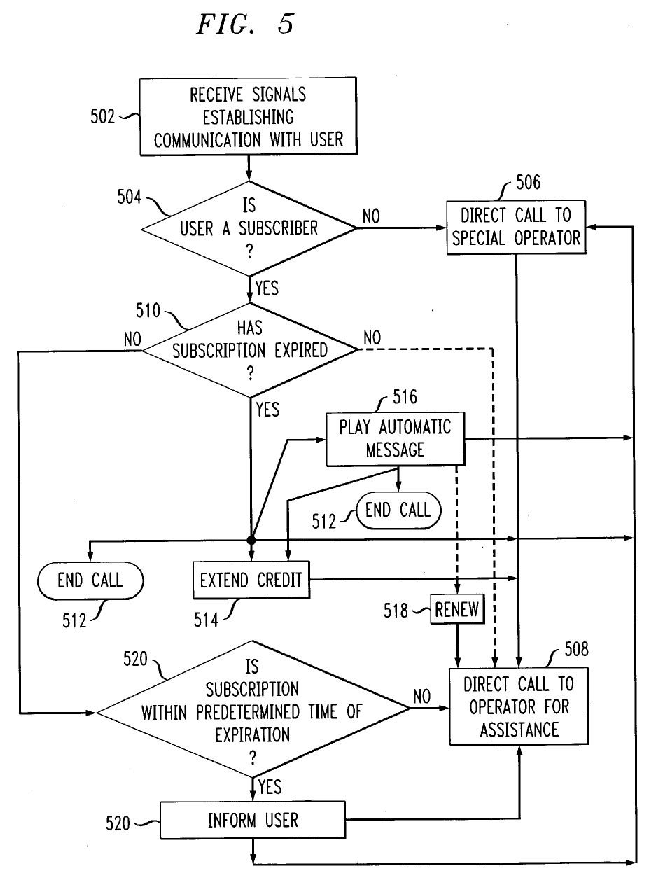

A method in accordance with this aspect of the invention is described with respect to flowchart 500 of FIG. 5. Signals establishing a communication connection with a user are received at step 502 and the status of the user as a subscriber or non-subscriber is determined in step 504. If the user is not a subscriber, the call may be directed to a special operator for special handling in step 506. The call is then directed to an operator for information assistance in step 508. These steps have been discussed above. As in the embodiment of FIG. 4a, step 406 is optional in this embodiment if it is found that the user is not a subscriber.

If the user is a subscriber, it is determined whether the user's subscription has expired in step 510. Information server 32 may be programmed to compare the date of the current call with the expiration date to determine whether the current date is after the expiration date.

If the subscription has expired, there may be several options. The call may be ended, in step 512. Credit may be extended for the current call, in step 514, and the call may then be directed to an operator for information assistance, in step 508. The call may be directed to a special operator to discuss renewal of the subscription in step 506, followed by directing the call to an operator for assistance, in step 508. Another option is to play an automatic message in step 516, giving the user the option to renew the subscription in step 518, request credit in step 514, direct the call to the special operator in step 506, or to end the call in step 512, by appropriate entry through the phone or other communications device.

If the subscription has not expired, one option is to direct the call to an operator for information assistance in step 506, as indicated by a phantom line. For example, information server 32 may send a signal to switch host computer 124, in response to which the computer directs the call to an available operator at an operator terminal 106.

Alternatively, if the subscription has not expired in step 510, it may be further determined whether the subscription is within a predetermined time period prior to expiration, in step 520. Information server 32 may be programmed to compare the current date with the expiration date and compare the difference to the time period.

If the difference is not within the time period, the call is directed to an operator for information assistance, in step 508. Information server 32 may send a signal to switch host computer 124 that the call may be directed to the information assistance operator.

If the subscription is within a predetermined time period prior to expiration, the user may be informed in step 520. The user may be informed by an automatic recording output by voice server 118 under the control of switch host computer 124, for example. The recording may include the option of renewing by suitable inputs through the user's phone or other such communications device. The recording may also include the option of being connected to the special operator to discuss renewal, in step 506. Information server 32 may provide a signal to switch host computer 124 to inform the user by playing the automatic message or by other means. After informing the user in step 520 or after the user speaks to the special operator in step 506, the call may be directed to a information assistance operator for assistance in step 508 by switch host computer 124, for example. The system 10 may notify the subscriber by a method selected by the subscriber. For example, while setting up an account or at a later time, a subscriber may identify that they would prefer to receive such notifications by phone, facsimile, e-mail, etc., and provide contact information.

It will be apparent to one skilled in the art that the status of multiple parameters may be checked and calls handled based on any one or more of the multiple parameters, as well. For example, the status of both usage limits and expiration dates may be checked and a call handled based on the status of both parameters.

In another embodiment of the invention, when the current date is within a predetermined time period of the expiration date of a subscription and the subscription has not been renewed, system 10 automatically notifies the subscriber that their billing relationship is about to expire. Similarly, system 10 notifies the subscriber when their account has actually expired.

A method in accordance with this embodiment of the invention is described with respect to flowchart 600 in FIG. 6. A subscriber account is checked to identify the expiration date of the account, in step 602. For example, information server 32 may run a routine to check each subscriber folder or other location in information database 34 from time to time. Checks may be performed on a regular, predetermined basis, for example, such as once a week.

It is then determined whether the current date is within a predetermined time period prior to the expiration date, in step 604. For example, information server 32 may compare the current date to the expiration date and determine whether the difference is within the predetermined time period. The time period may be 30 days, for example.

If the difference is not within the predetermined time period, step 602 is returned to, by information server 32, for example, to check another subscriber account.

If the difference is within the predetermined time period, it is determined whether there is a contact preference established in the account, in step 608. For example, information server 32 may check the subscriber folder for such a preference.

If not, the subscriber is contacted by a default method, in step 610. The default method may be an automated phone call to the subscriber's phone number, for example.

If there is a contact preference, the subscriber is contacted by the preferred method to inform them of the pending expiration, in step 612. For example, information server 32 may cause an automatic message to be sent by automatic phone call, e-mail, facsimile and other methods described further, below, through transmission facility 38. Phone and other verbal messages may be generated by IVR unit 36, for example. The content of other types of messages may be generated by information server 34. The message may differ based on the time left until expiration or if the subscription has actually expired. Messages may be sent at expiration and after expiration, as well.

Another subscriber account is then checked in step 602.

The subscriber may specify the method of transmission of the notification in their user profile, for example. If the subscriber specifies that the preferred method is via a phone call or facsimile, the subscriber would also provide an appropriate number for transmission of the message in their personal profile. Accordingly, information server 32 will send the phone call or facsimile through an appropriate telephone or facsimile facility, indicated schematically as transmission facility 38.

Alternatively, the subscriber may desire to be paged. In that case a pager number would be provided by the subscriber in the profile. A phone number to an automated message concerning the notification may be left on the pager. A URL to a webpage of system 10, including the notification, may be left on the pager, as well. A page may also be sent via the transmission facility 38.

As another alternative, the subscriber may wish to receive an e-mail of the notification. In that case, the subscriber would provide an e-mail address in their subscriber folder. Phone, facsimile, pages and e-mail messages may be sent via IASP 102 and servicing platform 104 if desired, as well.

The subscriber may alternatively desire to be informed of the status of the expiration of the subscription by a notice provided on the website of the system 10, which may be on web server 35 along with the subscriber's other account-related information, for example. The subscriber may use their account number, PIN and/or other password to access their account information, for example. Such information may be provided on the website in addition to notifying the subscriber through other modes of notification, as well.

Another specified method of transmission may be via SMS. Accordingly, information server 32 may send an SMS message concerning the pending expiration or actual expiration of the subscription via an SMS center (not shown). As is well known, an SMS is a store and forward service where short messages are not sent directly from a sender to a recipient but rather via an SMS center. A conventional mobile telephone network that supports SMS has one or more SMS centers to handle and manage the short messages.

Yet another specified method of transmission of the specialized communications services may be via a wireless application protocol (“WAP”) site. As is well known, to enable mobile devices to effectively access the Internet through the wireless network, which is not an ideal network for such access as it typically affords low bandwidth, high latency and unreliable connections, a WAP standard for the mobile devices has been developed to overcome the particular constraints of the wireless environment.

For example, similar to the Internet standards, WAP specifies use of a wireless markup language (“WML”), which is a subset of an extensible markup language (“XML”), for writing WAP content. WML is designed to make optimum use of a small display which is typical of a mobile device. The resulting WAP content is scalable, e.g., from a two-line text display to a full graphic screen of a larger display. The WAP content can be read by a user using WAP microbrowser software installed in the mobile device. The communications between the mobile device and the Internet is through a WAP gateway, which serves as an interface between a wireless network and the Internet.

The WAP gateway provides the necessary protocol translation (e.g., between WAP and transmission control protocol/Internet protocol (TCP/IP)) and optimization, security, activity tracking and administration. Messages communicated between a mobile device and the WAP gateway are in accordance with a WAP datagram protocol (“WDP”). For example, when a request comprising a URL is sent from the mobile device via a wireless network to the WAP gateway, the request includes a device ID identifying the mobile device. In response, a hypertext transfer protocol (“HTTP”) interface in the gateway retrieves the requested content from the WAP site on the Internet at the URL. The retrieved content is converted into a compressed data format for transmission over the wireless network to the mobile device identified by its device ID. The WAP microbrowser software in the mobile device interprets the compressed data and displays the interactive WAP content.

Accordingly, the URL of the WAP site may be provided by the subscriber in the subscriber folder, expressed in WML.

Similarly, the notification may be expressed in HTML or XML, for example, and placed on a secure website for the subscriber to access anytime using a device running the necessary web browser software. The particular URL of the website may be designated to the subscriber exclusively for the subscriber's personal use. The subscriber may be notified by any of the methods described above, or other methods, such as e-mail, paging, instant messaging, etc, that a notification for the subscriber is available.

A message may be sent by conventional mail services, as well.

The foregoing merely illustrates the principles of the invention. It will thus be appreciated that those skilled in the art will be able to devise numerous other arrangements which embody the principles of and are within the spirit and scope of the invention, which is defined in the claims below.

For example, the embodiments of the invention apply regardless of whether feature group D (FGD) type signaling, SS7 out-of-band signaling or other signaling is used for communications between carrier switches and switch 120 of FIG. 2a.

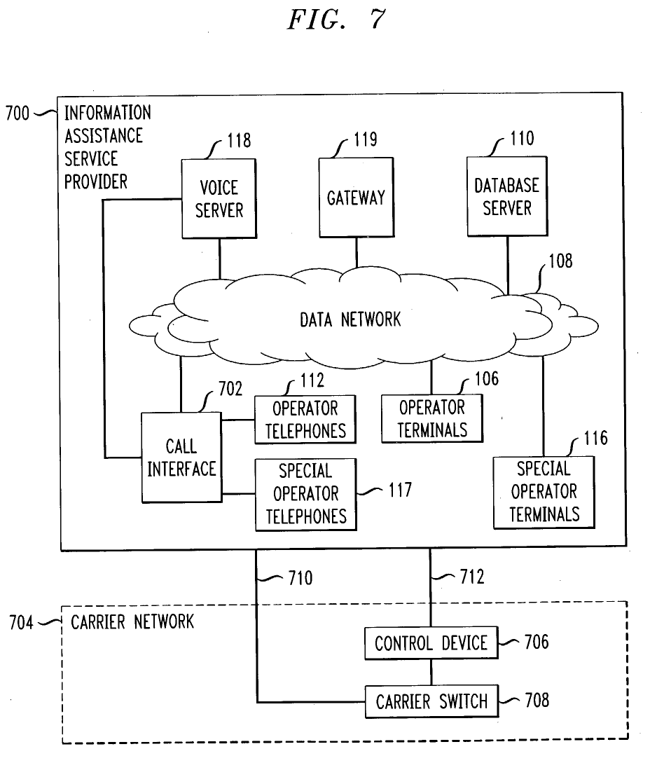

In addition, IASP 100 may be configured differently from the configuration of FIG. 2a. FIG. 7 illustrates an alternative IASP 700. Components common to IASC 100 are commonly numbered. In IASP 700, call interface 702 is not connected to servicing platform 104, as in IASP 200. Instead, the functionality of servicing platform 104 principally is carried out in carrier network 704. Control device 706 in network 704 performs similar functions to switch host computer 124, and carrier switch 708 performs not only its conventional carrier switching functions, but also those of servicing switch 120 described above, under control of device 706.

In IASP 700, a communication, such as an information assistance call, is recognized by control device 706 when it is routed through carrier switch 708. Device 706 causes the communication to be connected through one of pre-designated direct inward dial (DID) connections 710 to provider 700. Control device 706 may also be connected to IASP 700 via an Internet connection 712. The communication is received by call interface 702 therein. Interface 702, connected to operator telephones 112 and special operator telephones 117, includes the aforementioned ACD logic for distributing the call to an operator at one of telephones in a conventional manner. Calls are handled in the same manner as described above.

In addition, IASC 100 and IASC 700 are disclosed herein in a form in which various functions are performed by discrete functional blocks. However, any one or more of these functions could equally well be embodied in an arrangement in which the functions of any one or more of those blocks, or indeed, all of the functions thereof, are realized, for example, by one or more appropriately programmed processors.

While in the description above, the communications system 10 is said to be an information assistance system, the present invention may be used in other types of communications systems that are subscription based and/or include accounts with parameters to be managed and expiration dates.

What is claimed is:

1. A method of operating a communications system, comprising:
receiving signals in establishing a communication with a user, the signals containing an identifier;
determining if the user is a subscriber to the system based, at least in part, on the identifier; and
handling the communication based, at least in part, on whether the user is a subscriber to the system.

2. The method of claim 1, wherein the system comprises memory and subscriber data is stored in the memory, the subscriber data being associated with the identifier, the method further comprising:
determining if the user is a subscriber by searching the memory for the subscriber data associated with the identifier.

3. The method of claim 1, wherein the communications system is an information assistance service system, the method further comprising:
receiving signals in establishing a communication with the user making an information assistance call to the information assistance service system.

4. The method of claim 3, wherein the identifier is an automatic number identification.

5. The method of claim 3, wherein the system comprises memory, the identifier is a communications number of the source of the communication and communications numbers of the subscribers are stored in memory, the method further comprising:
searching the memory for the communications number of a call.

6. The method of claim 3, wherein the system comprises memory, the memory storing at least one folder of data for each subscriber, each folder being associated with at least one communications number of a respective subscriber, the method further comprising:
determining if the user is a subscriber by searching for a folder associated with the communications number corresponding to the identification.

7. The method of claim 3, wherein the system comprises at least one first operator device to provide information assistance and at least one second operator device, the method further comprising:
handling the communication by directing the communication to a second operator device, if the user is not a subscriber.

8. The method of claim 3, wherein the system comprises at least one first operator device to provide information assistance and at least one second operator device, the method further comprising:
handling the communication by directing the communication to a first operator device if the user is a subscriber.

9. The method of claim 1, wherein the system comprises at least one first operator device to provide a service and at least one second operator device, the method further comprising:
handling the communication by directing the communication to a second operator device if the user is not a subscriber.

10. The method of claim 1, wherein the system comprises at least one first operator device to provide a service and at least one second operator device, the method further comprising:
handling the communication by directing the communication to a first operator device if the user is a subscriber.

11. The method of claim 3, further comprising:
if the user is a subscriber, determining a status of a parameter associated with the subscriber; and
handling the communication based, at least in part, on the status of the parameter.

12. The method of claim 11, wherein the parameter is at least one of usage limits and expiration date, the method further comprising:
determining if the parameter is exceeded; and
handling the communication based, at least in part, on whether the parameter is exceeded.

13. The method of claim 1, further comprising:
if the user is a subscriber, determining a status of a parameter associated with the subscriber; and
handling the communication based, at least in part, on the status of the parameter.

14. The method of claim 3, further comprising, if the user is not a subscriber, handling the communication by playing a message.

15. The method of claim 3, further comprising handling the communication by directing the communication to an operator device and displaying a display based, at least in part, on whether the user is a subscriber.

16. A communications system comprising:
an interface to receive signals to establish a communication with a user, the signals containing an identifier;
memory storing identifying information of subscribers to the system; and
a processor coupled between the memory and the interface, the processor being programmed to determine if the user is a subscriber based, at least in part, on the identifier and the identifying information in the memory;
wherein the system handles the communication based, at least in part, on whether the user is a subscriber.

17. The system of claim 16, wherein the communications system is an information assistance service system, the system further comprising:
at least one information assistance service provider subsystem to receive an information assistance call from the interface;
wherein at least one information assistance service provider subsystem comprises a plurality of operator devices.

18. The system of claim 17, further comprising:
a plurality of information assistance service provider subsystems coupled to the memory and the processor through a network; and
at least one interface coupled to the plurality of information assistance service provider subsystems.

19. The system of claim 18, wherein the network is a wide area network.

20. The system of claim 18, wherein the network is one of an internet based network and an intranet based network.

21. The system of claim 18, wherein each of the plurality of information assistance service provider subsystems comprises a respective switching subsystem.

22. The system of claim 18, wherein each information assistance service provider subsystem comprises:
at least one first operator device to receive a communication from a subscriber;
at least one second operator device to receive a communication from a non-subscriber;
a second processor coupled to the first processor, the second processor being programmed to direct a communication to one of the first and second operator devices based on whether the user is a subscriber.

23. The system of claim 22, wherein the first operator device is an information assistance operator device.

24. A communications system comprising:
receiving means for receiving signals for establishing a communication with a user, the signals containing an identifier;
determining means for determining if the user is a subscriber to the system based, at least in part, on the identifier; and
handling means for handling the communication based, at least in part, on whether the user is a subscriber to the system.

25. A method of operating a communications system, wherein a subscriber to the system has a subscriber account with the system, the method comprising:
receiving signals to establish a communication with a subscriber to the system, the signals containing an identifier;
identifying the subscriber based on the identifier; and
handling the communication based, at least in part, on a status of at least one parameter of the subscriber's account.

26. The method of claim 25, wherein the parameter is a usage limit, the method further comprising:
determining whether a usage limit is associated with the subscriber's account.

27. The method of claim 26, wherein the communications system is an information assistance system, the method further comprising:
receiving signals to establish a communication with a subscriber making an information assistance call to the information assistance system.

28. The method of claim 27, wherein the system comprises at least one first operator device to provide information assistance and at least one second operator device, the method further comprising:
handling the communication by directing the communication to a second operator device if a usage limit is exceeded.

29. The method of claim 28, further comprising directing the communication to the first operator device after directing the communication to the second operator device.

30. The method of claim 27, wherein the system comprises at least one first operator device to provide information assistance and at least one second operator device, the method further comprising:
handling the communication by directing the communication to a first operator device if the usage limit is not exceeded.

31. The method of claim 27, comprising handling the communication by ending the communication if a usage limit is exceeded.

32. The method of claim 27, wherein the system comprises at least one first operator device to provide information assistance and at least one second operator device, the method further comprising:
extending the usage limit if the usage limit is exceeded; and
handling the communication by directing the communication to a first operator device.

33. The method of claim 26, further comprising:
handling the communication based on whether current usage is within a predetermined range of the usage limit.

34. The method of claim 33, further comprising handling the communication by informing the subscriber that the current usage of subscriber is within the predetermined range of the usage limit.

35. The method of claim 26, wherein a subscription account includes multiple parties and the communication is initiated by one of the multiple parties, the method further comprising:
determining whether a usage limit is associated with the one of the multiple parties.

36. The method of claim 26, further comprising handling the communication by directing the communication to an operator device and displaying a display based, at least in part, on the status of the usage limit.

37. The method of claim 25, wherein the parameter is an expiration date of the subscription, the method further comprising:
identifying the expiration date of the subscriber's account.

38. The method of claim 37, wherein the communications system is an information assistance service system, the method further comprising:
receiving signals to establish a communication with a subscriber making an information assistance call to the information assistance service system.

39. The method of claim 38, wherein the system comprises at least one first operator device to provide information assistance and at least one second operator device, the method further comprising:
handling the communication by directing the communication to a first operator device, if the expiration date is not exceeded.

40. The method of claim 38, further comprising:
handling the communication by ending the communication, if the expiration date is exceeded.

41. The method of claim 38, wherein the system comprises at least one first operator device to provide information assistance and at least one second operator device, the method further comprising:
handling the communication by extending credit to complete the communication if the expiration date is exceeded; and
directing the communication to a first operator device.

42. The method of claim 38, wherein the system comprises at least one first operator device to provide information assistance and at least one second operator device, the method further comprising:
handling the communication by directing the communication to a second operator device if the expiration date is exceeded.

43. The method of claim 38, further comprising:
handling the communication based on whether the current date is within a predetermined time period prior to the expiration date.

44. The method of claim 43, further comprising handling the communication by communicating with the subscriber about the expiration date.

45. The method of claim 44, wherein the system comprises at least one first operator device to provide information assistance and at least one second operator device, the method further comprising:
directing the communication to a second operator device to communicate about the expiration date; and then, and
directing the communication to a first operator device.

46. The method of claim 26, wherein the at least one parameter comprises both usage limits and expiration dates.

47. A communications system, wherein a subscriber to the system has a subscriber account with the system, the system comprising:
an interface to receive signals to establish a communication with a subscriber to the system, the signals containing an identifier;
memory storing identifying information of subscribers to the system; and
a processor coupled between the memory and the interface, the processor being programmed to determine the identity of a subscriber based on the identifier;
wherein the system handles the communication based, at least in part, on a status of at least one parameter of a subscriber's account.

48. The system of claim 47, wherein the processor is programmed to check the status of the at least one parameter.

49. The system of claim 48, wherein the parameter is a usage limit.

50. The system of claim 48, wherein the parameter is an expiration date of the subscription.

51. The system of claim 48, wherein the system is an information assistance service system comprising:
an information assistance service provider subsystem coupled between the interface and the processor, the information assistance service provider subsystem comprising:
at least one first operator device to provide information assistance;
at least one second operator device; and
a second processor coupled to the first processor, the second processor programmed to direct the communication to one of the first and second operator terminals dependent on signals received from the first processor.

52. A communications system, wherein a subscriber to the system has a subscriber account with the system, the system comprising:
means for receiving signals to establish a communication with a subscriber to the system, the signals containing an identifier;
means for identifying the subscriber based on the identifier;
means for handling the communication based, at least in part, on a status of at least one parameter of the subscriber's account.

53. The system of claim 49, wherein the parameter is at least one of a usage. limit and an expiration date.

54. A method of operating a communications system, wherein at least some users of the system are subscribers having subscriptions to the system, the subscriptions having expiration dates, the method comprising:
informing a subscriber of an expiration date by a contact preference method selected by the subscriber.

55. The method of claim 54, wherein the contact preference method includes at least a selected one of a telephone call, a facsimile, an e-mail, a system website notice, a page, an SMS message, a wireless application protocol (WAP) message, an instant message and a letter.

56. The method of claim 54, further comprising:
determining if a current date is within a predetermined period of time before an expiration date of an account; and, if so,
informing the subscriber of the expiration date by the contact preference method.

57. The method of claim 56, wherein the system comprises memory storing the expiration date, the method further comprising:
searching the memory for the expiration date of a subscription.

58. The method of claim 57, wherein the expiration date is stored in a folder in the memory.

59. The method of claim 57, wherein the selected contact preference method is stored in memory, the method further comprising:
searching the memory for the contact preference method if the current date is within the predetermined period of time before the expiration date.

60. The method of claim 58, wherein the contact preference method is stored in the folder in memory.

61. The method of claim 54, wherein the system comprises memory storing the contact preference method, the method further comprising:
searching the memory for the contact preference method.

62. The method of claim 54, wherein the system comprises memory storing the expiration date, the method further comprising searching the memory for the expiration date.

63. The method of claim 54, wherein the communications system is an information assistance service system.

64. A communications system, wherein at least some users are subscribers having subscriptions to the system, the subscriptions having expiration dates, the system comprising:
memory storing subscriber information, the information comprising an expiration date and a contact preference method selected by the subscriber; and
a processor programmed to inform a subscriber of an expiration date via the contact preference method stored in memory.

65. The system of claim 64, wherein the contact preference method includes at least a selected one of a telephone call, a facsimile, an e-mail, a system website notice, a page, an SMS message, a wireless application protocol (WAP) message, an instant message and a letter.

66. The system of claim 64, wherein the processor is further programmed to search the memory for an expiration date of an account.

67. The system of claim 66, wherein the processor is further programmed to determine whether a current date is within a predetermined time period prior to the expiration date.

68. The system of claim 67, wherein the processor is further programmed to search the memory for a contact preference method associated with the account, if the current date is within the predetermined time period prior to the expiration date.

69. The system of claim 68, wherein the expiration date is stored in the subscriber folder stored in the memory.

70. The system of claim 69, wherein the contact preference method is stored in the subscriber folder stored in memory.

71. The system of claim 64, wherein the processor is further programmed to search the memory for a contact preference method associated with the account.

72. The system of claim 64, wherein the contact preference method is stored in a subscriber folder stored in memory.

73. The system of claim 64, wherein the memory is a database.

74. The system of claim 64, wherein the system is an information assistance system, the system further comprising:
an interface to receive signals to establish a communication with a user; and
an information assistance service provider subsystem coupled between the interface and the processor.

75. The system of claim 64, further comprising a transmission facility coupled to the processor to transmit a message by the contact preference method.

76. A communications system, wherein at least some users are subscribers having subscriptions to the system, the subscriptions having expiration dates, the system comprising:
means for receiving signals to establish a communication with a user; and
means for informing a subscriber of an expiration date by a contact preference method selected by the subscriber.

77. A method of operating communications system, comprising:
establishing a communication with a user;
determining if the user is a subscriber to the system based, at least in part, on a voice print of the user; and
handling the communication based, at least in part, on whether the user is a subscriber to the system.

78. A method of operating an information assistance service communications system, comprising:
establishing a communication with a user making an information assistance call to the information assistance service communications system;
determining if the user is a subscriber to the information assistance service communications system based, at least in part, on an identifier received after the communication is established; and
handling the communication based, at least in part, on whether the user is a subscriber to the information assistance service communications system.

79. The method of claim 78, wherein the identifier is a selected one of a voice print, a personal identification number and an account number.

80. A method of operating a communications system, wherein a subscriber to the system has a subscriber account with the system, the method comprising:
establishing a communication with a subscriber to the system;
identifying the subscriber based on a voice print of the subscriber; and
handling the communication based, at least in part, on a status of at least one parameter of the subscriber's account.

81. A method of operating an information assistance service communication system, wherein a subscriber to the system has a subscriber account, the method comprising:
establishing a communication with a user making an information assistance service call to the information assistance service center;
identifying the subscriber based, at least in part, on an identifier received after the communication is established; and
handling the communication based, at least in part, on a status of at least one parameter of the subscriber's account.

82. The method of claim 81, wherein the identifier is a selected one of a voice print, a personal identification number and an account number.
